(19) United States
(12) Patent Application Publication
(10) Pub. No.: US 2013/0009096 A1
(43) Pub. Date: Jan. 10, 2013

(54) OXYNITRIDE PHOSPHOR AND METHOD OF MANUFACTURING THE SAME

(75) Inventors: CHENG-I CHU, TAIPEI CITY (TW); RU-SHI LIU, TAIPEI CITY (TW); YU-CHIH LIN, TAOYUAN (TW); CHEN-HONG LEE, TAOYUAN (TW); WEI-KANG CHENG, TAOYUAN (TW); YI-SHENG TING, TAOYUAN (TW); SHYI-MING PAN, TAOYUAN (TW)

(73) Assignee: FORMOSA EPITAXY INCORPORATION, TAOYUAN COUNTY (TW)

(21) Appl. No.: 13/541,890

(22) Filed: Jul. 5, 2012

(30) Foreign Application Priority Data
Jul. 5, 2011 (TW) 100123638

(51) Int. Cl. C09K 11/79

(52) U.S. Cl. 252/301.4 F

(57) ABSTRACT

An oxynitride phosphor and a method of manufacturing the same are revealed. The formula of the oxynitride phosphor is Ba_{3-x-y}Si₆O₁₂N₂:Ce_{y}, Euₓ (0≦x≦1, 0≦y≦1). Europium (Eu) and cerium (Ce) are luminescent centers. The oxynitride phosphor is synthesized by solid-state reaction. The oxynitride phosphor is excited by vacuum ultraviolet light with a wavelength range of 130 nm to 300 nm or ultraviolet to visible light with a wavelength range of 350 nm to 550 nm. The emission wavelength of the oxynitride phosphor is ranging from 400 nm to 700 nm. Thus the oxynitride phosphor can be applied to plasma display panels and ultraviolet (UV) excitation sources. The energy transfer occurs between Ce and Eu of the oxynitride phosphor and the oxynitride phosphor has a blue light emission peak and a green light emission peak. Thus color rendering index of the oxynitride phosphor is improved.

### BACKGROUND OF THE INVENTION

1. Fields of the Invention

The present invention relates to a phosphor and a method of manufacturing the same, especially to an oxynitride phosphor and a method of manufacturing the same.

2. Descriptions of Related Art

In order to save energy, reduce carbon emission, and protect the environment, conventional light sources are gradually replaced by white-light LED (light emitting diode)-based lighting. The LED features on compact size, low power consumption, long life time, low heat emission, and short reaction time. LED is easy to install in equipment, of low heat radiation, and used for high frequency operation and over 100 thousand hours. It uses only one-eighths or one-tenths power in comparison with conventional light bulbs and a half power compared with fluorescent lights. LED overcomes a plurality of shortcomings of incandescent bulbs. Thus the white-light LED is a new light source for illumination and displays of the 21st century. It is called green light source due to its features of energy saving and environment protection.

Refer to U.S. Pat. No. 5,998,925 applied by Japanese Nichia Corporation filed in 1996, a light emitting diode (LED) includes a semiconductor element emitting blue light and a phosphor activated with cerium The phosphor is Cerium-doped yttrium aluminum garnet (YAG:Ce) that emits yellow light. Thus the LED emits white light by blending the blue light and the yellow light emitted by the phosphor. Although the nitride phosphors available now are of better thermal resistance and water resistance, its cost is high. The cost of oxide phosphors is low yet it has poor thermal stability and poor water resistance. Thus oxynitride phosphors have received considerable attention compared to the existing nitride and oxide phosphors. The precursor for synthesis of the oxynitride phosphors does not include nitride with extreme air-sensitivity. The synthesis temperature is reduced by using a part of oxides. Moreover, the oxynitride phosphors have good stability similar to that of the nitrides. The oxynitride phosphors have advantages of both oxides and nitrides. Thus a plurality of oxynitride phosphors including β-SiAlON, MSi₂O₂N₂ (M=Ca, Sr, Ba), etc. has been developed recently.

As to the oxynitride phosphor MₓA_{y}B_{z}OᵤNᵥ (0.00001≦y≦3; 0.00001≦z≦6; 0.00001≦u≦12; 0.00001≦v≦12; 0.00001≦x≦5), wherein M is a single active center or a mixture of active centers. A is a bivalent element or a mixture of a plurality of bivalent elements. B can be a trivalent element, a tetravalent element, a mixture of a plurality of trivalent elements or a mixture of a plurality of tetravalent elements. O is a univalent element, a bivalent element, a mixture of a plurality of univalent elements, or a mixture of a plurality of bivalent elements. N is a univalent element, a bivalent element, a trivalent element, a mixture of a plurality of univalent elements, a mixture of a plurality of bivalent elements, or a mixture of a plurality of trivalent elements. This chemical formula has been developed and patented by OSRAM GESELLSCHAFT MIT BESCHRANKTER HAFTUNG in 2008 with the Pat. App. No. PCT/EP2008/059726 and the title is “TEMPERATURE-STABLE OXYNITRIDE PHOSPHOR AND LIGHT SOURCE COMPRISING A CORRESPONDING PHOSPHOR MATERIAL”.

In 2009, Mitsubishi Chemical Corporation has also applied for the patent with Pub. No. WO/2009/017206, App. No. PCT/JP2008/063802 filed on Jul. 31, 2008 and the title is “PHOSPHOR AND METHOD FOR PRODUCING THE SAME, CRYSTALLINE SILICON NITRIDE AND METHOD FOR PRODUCING THE SAME, PHOSPHOR-CONTAINING COMPOSITION, LIGHT-EMITTING DEVICE USING THE PHOSPHOR, IMAGE DISPLAY DEVICE, AND ILLUMINATING DEVICE”. A pure product revealed in this patent is synthesized under normal pressure and is obtained by using pre-treated silicon nitride (Si₃N₄) precursor. In recent years, phosphors excited by light emitting diode are applied to lighting devices. Phosphors with high color rendering indices are required. The above patents don't disclose formula of phosphors with high color rendering indices.

### SUMMARY OF THE INVENTION

Therefore it is a primary object of the present invention to provide an oxynitride phosphor and a method of manufacturing the same. The energy transfer occurs between Ce and Eu of the oxynitride phosphor so as to increase emission spectra range and improve color rendering index of the oxynitride phosphor.

It is another object of the present invention to provide an oxynitride phosphor and a method of manufacturing the same in which energy transfer occurs between Ce and Eu of the oxynitride phosphor. Thus the amount of europium oxide used is reduced.

It is a further object of the present invention to provide an oxynitride phosphor and a method of manufacturing the same. The oxynitride phosphor is excited by vacuum ultraviolet light with a wavelength range of 130 nm to 300 nm or light with a wavelength range of 300 nm to 550 nm. The emission wavelength of the oxynitride phosphor is ranging from 400 nm to 700 nm. Thus the oxynitride phosphor is suitable for plasma display panels and UV excitation sources.

It is a further object of the present invention to provide an oxynitride phosphor and a method of manufacturing the same. A precursor is sintered under high pressure and high temperature for synthesis of the oxynitride phosphor. The manufacturing process is simple and the phosphor can be mass-produced.

In order to achieve the above objects, an oxynitride phosphor of the present invention is provided. The general formula of the oxynitride phosphor is Ba_{3-x-y}Si₆O₁₂N₂:Ce, Euₓ, wherein x is between 0 and 1 while y is also between 0 and 1. Ce and Eu are luminescent centers.

A method of manufacturing an oxynitride phosphor of the present invention is provided. The method includes steps of providing a precursor and sintering the precursor for synthesis of an oxynitride phosphor by using a solid-state reaction. The general formula of the oxynitride phosphor is Ba_{3-x-y}Si₆O₁₂N₂:Ce_{y}, Euₓ , wherein x is between 0 and 1 while y is also between 0 and 1. Ce and Eu are luminescent centers.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart of an embodiment according to the present invention;

FIG. 2 is a list showing a molar ratio of components of precursors of another embodiment according to the present invention;

FIG. 3 shows X-ray powder diffraction patterns of another embodiment according to the present invention;

FIG. 4 shows photoluminescence emission spectra of a third embodiment according to the present invention;

FIG. 5 shows photoluminescence excitation spectra of the third embodiment according to the present invention;

FIG. 6 shows vacuum ultraviolet emission spectra of the third embodiment according to the present invention;

FIG. 7 shows vacuum ultraviolet excitation spectra of the third embodiment according to the present invention.

### DETAILED DESCRIPTION OF THE PREFERRED EMBODIMENT

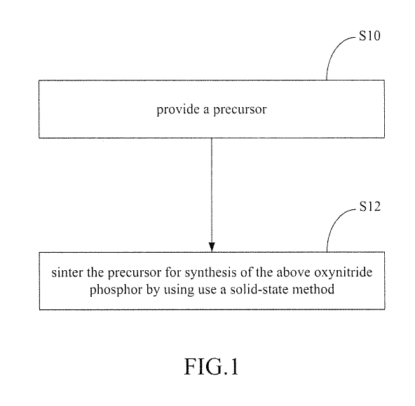

Refer to FIG. 1, an oxynitride phosphor of the present invention having a formula of Ba_{3-x-y}Si₆O₁₂N₂:Ce_{y}, Euₓ, wherein x is between 0 and 1 while y is also between 0 and 1 while Ce and Eu are luminescent centers. A method of manufacturing the oxynitride phosphor of the present invention includes following steps. First, take the step S10, provide a precursor. Then run the step S12, sinter the precursor for synthesis of the above oxynitride phosphor by using use a solid-state method (reaction). The precursor includes barium carbonate, silicon dioxide, silicon nitride, europium oxide, and cerium oxide. The precursor is sintered under the pressure from 0.1 to 1000 MPa and the temperature ranging from 1200 to 1800 degrees Celsius.

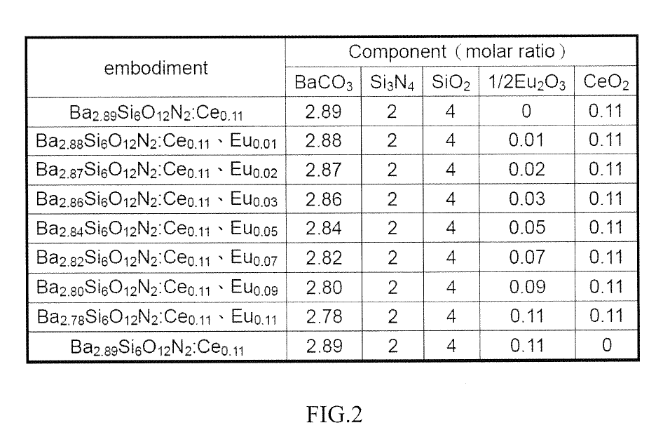

Refer to FIG. 2, a molar ratio of components of a precursor of another embodiment according to the present invention is listed. As show in the figure, this embodiment relates to manufacturing of Ba_{2.89}Si₆O₁₂N₂:Eu_{0.11}, Ba_{2.88}Si₆O₁₂N₂:Ce_{0.11}, Eu_{0.01}, Ba_{2.89}Si₆O₁₂N₂:Ce_{0.11}, etc. The precursor of Ba_{2.89}Si₆O₁₂N₂:E^{0.11} includes at least one of elements selected from barium carbonate (BaCO₃), silicon nitride (Si₃N₄), silicon dioxide (SiO₂), europium oxide (Eu₂O₃) and cerium oxide (CeO₂). As shown in FIG. 2, BaCO₃:Si₃N₄:SiO₂: ½Eu₂O₃:CeO₂=2.89:2:4:0.11:0. The precursor is ground and mixed evenly in a mortar. Then the precursor is sintered under nitrogen pressure of 0.92 MPa at 1375 degrees Celsius for 1 hour to get Ba_{2.89}Si₆O₁₂N₂:Eu_{0.11}. The Ba_{2.88}Si₆O₁₂N₂:Ce_{0.11}, Eu_{0.01} and Ba_{2.89}Si₆O₁₂N₂:Ce_{0.11} are produced in a similar way. The precursor of Ba_{2.88}Si₆O₁₂N₂:Ce_{0.11}, Eu_{0.01} also consists of barium carbonate (BaCO₃), silicon nitride (Si₃N₄), silicon dioxide (SiO₂), europium oxide (Eu₂O₃) and cerium oxide (CeO₂). BaCO₃:Si₃N₄:SiO₂:½Eu₂O₃:CeO=2.88:2:4:0.01:0.11. The precursor of Ba_{2.89}Si₆O₁₂N₂:Ce_{0.11} includes the same components while BaCO₃:Si₃N₄:SiO₂:½Eu₂O₃:CeO=2.89:2:4:0:0.11. Then the precursors are sintered under the same conditions to get Ba_{2.88}Si₆O₁₂N₂:Ce_{0.11}, Eu_{0.01} and Ba_{2.89}Si₆O₁₂N₂:Ce_{0.11}. The manufacturing process mentioned above is simple and the oxynitride phosphor can be mass-produced.

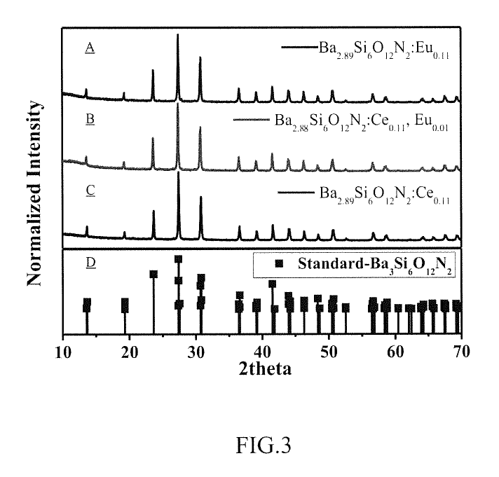

Refer to FIG. 3, another embodiment of the present invention is characterized by X ray powder diffraction (XRD). As shown in the figure, Ba_{2.89}Si₆O₁₂N₂:Eu_{0.11}, Ba_{2.88}Si₆O₁₂N₂:Ce_{0.11}, Eu_{0.01} and Ba_{2.89}Si₆O₁₂N₂:Ce_{0.11} synthesized by the solid-state reaction method are examined by X ray powder diffraction to access phase purity. The FIG. 3 shows the first X ray powder diffraction pattern A of Ba_{2.89}Si₆O₁₂N₂:Eu_{0.11}, the second X ray powder diffraction pattern B of Ba_{2.88}Si₆O₁₂N₂:Ce_{0.11}, Eu_{0.01}, the third X ray powder diffraction pattern C of Ba_{2.89}Si₆O₁₂N₂:Ce_{0.11}, the fourth X ray powder diffraction pattern D of Ba_{2.89}Si₆O₁₂N₂. It is learned that the oxynitride phosphors synthesized (Ba_{2.89}Si₆O₁₂N₂:Eu_{0.11}, Ba_{2.88}Si₆O₁₂N₂:Ce_{0.11}, Eu_{0.01} and Ba_{2.89}Si₆O₁₂N₂:Ce_{0.11}) is pure by comparing these X ray powder diffraction patterns.

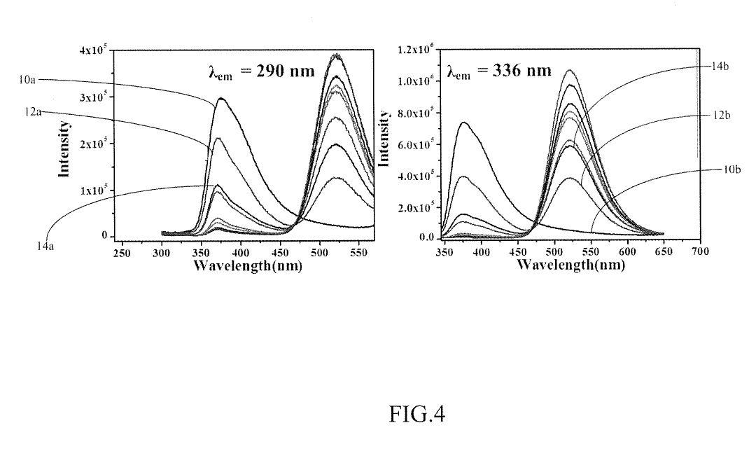

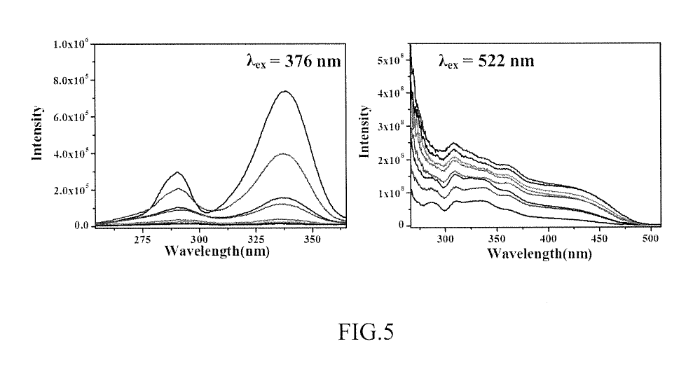

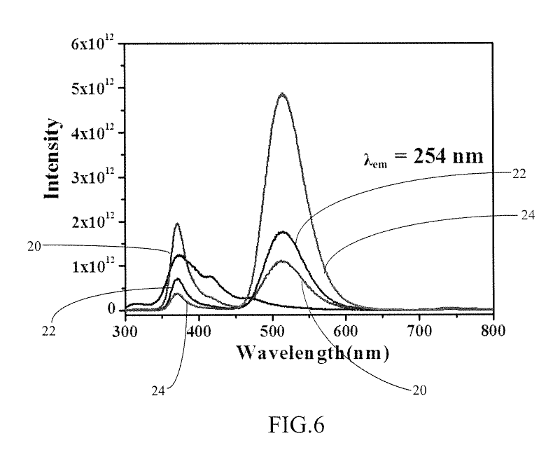

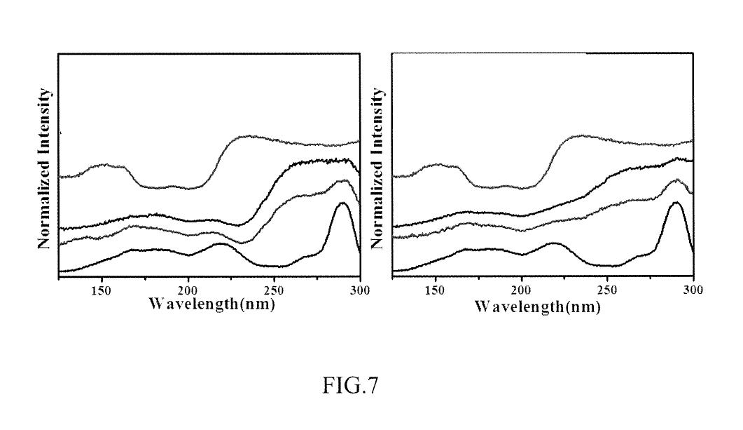

Refer to FIG. 4, FIG. 5, FIG. 6 and FIG. 7, excitation spectra and emission spectra of a further embodiment according to the present invention are revealed. As shown in the figures, Ba_{3-x-y}Si₆O₁₂N₂:Ce_{y}, Euₓ (wherein x is between 0 and 0.11 while y is 0 or 0.11) prepared is excited by light in the wavelength range from 350 nm to 550 nm or vacuum ultraviolet light in the wavelength range from 130 nm to 300 nm. The emission wavelength of Ce of the oxynitride phosphor is ranging from 300 nm to 480 nm and light emitted from Ce is blue. The emission wavelength of Eu is ranging from 480 nm to 650 nm and light emitted from Eu is green.

Refer to FIG. 5 and FIG. 7, the oxynitride phosphor of the present invention can be excited by ultraviolet light with a wavelength of 376 nm and 522 nm, and by vacuum ultraviolet light with a wavelength of 254 nm to emit green luminescence with a peak wavelength of 540 nm and blue luminescence with a peak wavelength of 376 nm. Thus the oxynitride phosphor is applied to ultraviolet (UV) excitation sources such as plasma display panels. Moreover, emission spectrum of the oxynitride phosphate is wide so that the Color Rendering Index is improved.

Refer to FIG. 4 and FIG. 6, the intensity ratio of green luminescence with a peak at 540 nm to blue light with a peak at 376 nm is found. The ratio changes due to different incident light energy. Thus the oxynitride phosphor can be used to sense, detect and change colors. When y of the oxynitride phosphor is fixed (y=0.11) and x is changed from 0 to 0.11, the intensity of blue luminescence with a peak at 376 nm is weaker along with increasing concentration of x while the intensity of green luminescence with a peak at 540 nm is getting stronger along with increasing concentration of x.

For example, the FIG. 4 shows two first curves 10a, 10b, two second curves 12a, 12b and two third curves 14a, 14b. The two first curves 10a, 10b are emission curves of Ba_{3-x-y}Si₆O₁₂N₂:Ce_{y}, Eu (x=0, y=0.11). The two second curves 12a, 12b are emission curves of Ba_{3-x-y}Si₆O₁₂N₂:Ce_{y}, (x=0.01, y=0.11). The two third curves 14a, 14b are emission curves of Ba_{3-x-y}Si₆O₁₂N₂:Ce_{y}, Euₓ (x=0.02, y=0.11). According to these curves, it is found that the intensity of blue luminescence with a peak at 376 nm is reduced along with increasing concentration of x while the intensity of green luminescence with a peak at 540 nm is getting stronger along with increasing concentration of x.

FIG. 6 shows emission spectra of oxynitride phosphor excited by vacuum ultraviolet light. There are the first curve 20, the second curve 22 and the third curve 24. The first curve 20 is an emission curve of Ba_{3-x-y}Si₆O₁₂N₂:Ce_{y}, Euₓ (x=0.11, y=0.02), the second curve 22 is an emission curve of Ba_{3-x-y}Si₆O₁₂N₂:Ce_{y}, Euₓ (x=0.11, y=0.05), and the third curve 24 is an emission curve of Ba_{3-x-y}Si₆O₁₂N₂:Ce_{y}, Euₓ (x=0, y=0.11). According to these curves, it is observed that the intensity of green luminescence with a peak at 540 nm is increased with increasing concentration of y while the intensity of blue luminescence with a peak at 376 nm is decreased with an increase in concentration of y.

According to FIG. 4 and FIG. 6, it is proved that energy transfer occurs between Ce and Eu. The energy transfer not only improves emission spectral range and color rendering index but also reduces the amount f the rare earth element, europium oxide (Eu₂O₃), used.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An oxynitride phosphor having a formula Ba_{3-x-y}Si₆O₁₂N₂:Ce_{y}, Euₓ, wherein x is ranging from 0 to 1 and y is ranging from 0 to 1; and
wherein cerium (Ce) and europium (Eu) are luminescent centers.

2. The oxynitride phosphor as claimed in claim 1, wherein an emission wavelength of Ce of the oxynitride phosphor is ranging from 300 nm to 480 nm; an emission wavelength of Eu is ranging from 480 nm to 650 nm.

3. The oxynitride phosphor as claimed in claim 1, wherein the oxynitride phosphor is excited by light with a wavelength range of 350 nm to 550 nm or 130 nm to 300 nm.

4. A method of manufacturing an oxynitride phosphor as claimed in claim 1 comprising the steps of:
providing a precursor; and
sintering the precursor by solid-state reaction for synthesis of an oxynitride phosphor.

5. The method as claimed in claim 4, wherein the precursor includes at least one of elements selected from barium carbonate, silicon dioxide, silicon nitride, europium oxide, and cerium oxide.

6. The method as claimed in claim 4, wherein a sintering temperature is ranging from 1200 degrees Celsius to 1800 degrees Celsius.

7. The method as claimed in claim 4, wherein sintering pressure is ranging from 0.1 MPa to 1000 MPa.
